(19) United States
(12) Patent Application Publication
(10) Pub. No.: US 2023/0220937 A1
(43) Pub. Date: Jul. 13, 2023

(54) SPUD WELD CONNECTION AND METHOD OF MAKING THE SAME

(71) Applicant: A. O. Smith Corporation, Milwaukee, WI (US)

(72) Inventors: Timothy Day, Milwaukee, WI (US); Bruce Krakauer, Brookfield, WI (US); Jason Scott, Elkhorn, WI (US)

(21) Appl. No.: 17/899,254

(22) Filed: Aug. 30, 2022

(51) Int. Cl. F16L 41/08; B23K 11/08

(52) U.S. Cl. CPC F16L 41/082; B23K 11/082; B23K 2101/04

(57) ABSTRACT

A spud connection to a cylindrical tank wall includes a spud body welded to a cylindrical tank wall. In at least some embodiments, the spud body has an arcuate and concave first end surface, and a planar second end surface spaced apart from the first end surface. A weld joint between the first end surface of the spud body and an outer surface of the cylindrical tank wall surrounds an aperture that extends through the cylindrical tank wall, so that a leak-free fluid connection to an interior volume of the tank can be achieved.

### BACKGROUND

Spud connection points are typically provided at external surfaces of liquid tanks. Such spud connections allow for access to the internal volume of the tank, such as to connect plumbing lines, control devices, measurement devices, and the like in a leak-free fashion. Often, such spuds are connected to the tank wall via welding.

Spud weld connections for cylindrical tanks such as water heaters are known to be locations at which tank failure (e.g. leakage) is prone to occur. Failures at these connections typically result from cyclic fatigue, caused by pressure and/or temperature cycling. Such cycling causes high stresses to occur at the weld connection locations, as the presence of the welded spud creates a stress riser at that location. The extent to which the shell is locally deformed by the welding of the spud can strongly influence the magnitude of the stress riser, and therefore can impact the fatigue life of the tank.

### SUMMARY

A spud weld connection according to embodiments of the present invention alleviates the known fatigue issues by reducing the stress riser that is created during traditional spud weld attachment.

In embodiments of the present invention, a spud connection to a cylindrical tank wall includes a spud body welded to a cylindrical tank wall. In at least some embodiments, the spud body has an arcuate and concave first end surface, and a planar second end surface. The planar second end surface is spaced apart from the first end surface, and an outer surface is arranged between the first and second end surfaces. A central bore extends through the spud body. In some embodiments, the central bore includes a female thread profile.

In at least some embodiments, the spud weld connection includes a weld joint between the first end surface of the spud body and an outer surface of the cylindrical tank wall. The weld joint surrounds an aperture that extends through the cylindrical tank wall, so that a leak-free fluid connection to an interior volume of the tank can be achieved.

In some embodiments the first end surface is concentric with the cylindrical tank wall. In such embodiments, the arcuate and concave shape of the first end surface defines an axis of revolution that is aligned with a central axis of the cylindrical tank wall. In other embodiments, the arcuate and concave shape of the first end surface defines an axis of revolution that is parallel to, but offset from, the central axis of the cylindrical tank wall. In some such embodiments the concave and arcuate shape defines a diameter that is greater than an outer diameter of the cylindrical tank wall, while in other such embodiments the concave and arcuate shape defines a diameter that is less than the outer diameter of the cylindrical tank wall. In some embodiments the outer diameter of the cylindrical tank wall is between 70% and 150% of a diameter defined by the concave and arcuate shape of the first end surface of the spud body.

According to another embodiment of the invention, a method of creating a spud weld connection to a cylindrical tank wall includes providing a cylindrical tank wall with an aperture extending therethrough, and also providing a spud body that has an arcuate and concave first end surface, a planar second end surface spaced apart from the first end surface, an outer surface arranged between the first and second end surfaces, and a central bore extending through the spud body. The first end surface of the spud body is disposed against an outer surface of the cylindrical wall such that the first end surface surrounds the aperture, and a weld joint is created around the aperture between the spud body and the cylindrical tank wall at the first end surface.

In at least some embodiments, creating the weld connection includes placing a planar surface of a first welding electrode against the planar second end surface of the spud body, and placing an arcuate and convex surface of a second welding electrode against an inner surface of the cylindrical tank wall. A compressive force is applied to the spud body and the cylindrical tank wall through the first and second electrodes, and an electrical current is conducted through the spud body and the tank wall between the first and second electrode in order to create the weld joint.

In at least some embodiments, the second welding electrode has a protrusion that extends from the arcuate and convex surface, and the method includes inserting the protrusion into the aperture of the tank in order to align the second welding electrode with the first welding electrode.

### BRIEF DESCRIPTION OF THE DRAWINGS

FIG. 1 is a perspective view of a water heater tank with spud connections according to an embodiment of the invention.

FIG. 2 is a perspective view of a tank spud for use in some embodiments of the invention.

FIG. 3 is a cross-sectional view of the tank spud of FIG. 2, viewed along the direction III-III.

FIG. 4 is a partial section view of a spud weld connection being made according to an embodiment of the invention.

FIG. 5 is a perspective view of a welding electrode for use in making a spud weld connection according to some embodiments.

FIG. 6 is a partial section view of a spud weld connection according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

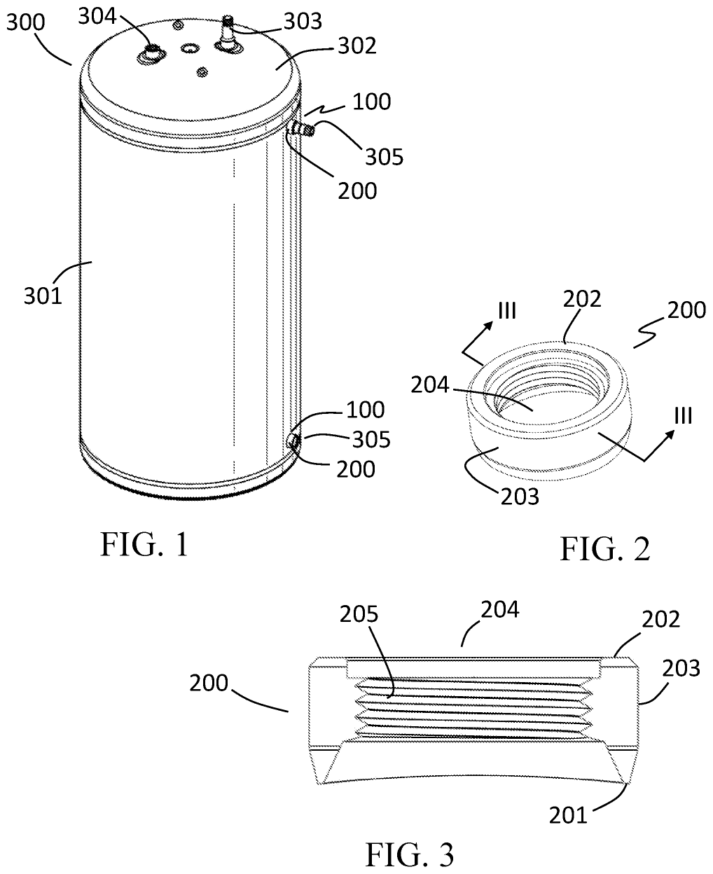

A water heater tank 300 with two spud weld connections 100 according to an embodiment of the present invention is depicted in FIG. 1. The water heater tank 300 is constructed from a cylindrical tank wall 301 that is, for example, rolled from steel sheet material. A formed upper tank head 302 is welded to the cylindrical tank wall 301 at a top end of the tank in order to seal that end of the tank, and a formed lower tank head (not shown) is welded to the opposing end of the tank in order to seal that end. The tank 300 can be used to store and/or heat water, and can optionally include heating means such as a burner and flue gas heat exchanger, one or more electrical heating elements, a refrigerant heat pump system, or others.

The water heater tank 300 is equipped with a water inlet port 303 and a water outlet port 304 that are welded to the upper tank head 302. The water inlet port 303 (which can optionally include a dip tube extending into the tank volume to a location near the lower end of the tank) allows for cold water to flow into the tank, and the outlet port 304 allows for heated water to be drawn from the tank 300 and delivered to users upon a demand for heated water.

A pair of additional ports 305 are provided at the cylindrical tank wall 301 itself, by way of the spud weld connections 100. The ports 305 can be used to, for example, circulate a flow of water from one portion of the tank 300 by way of one of the ports 305 to an external heat sink or heat source, and to return that flow of water back to the tank 300 by way of another of the ports 305. It should be understood that while a pair of ports 305 are depicted in FIG. 1, there can optionally be fewer or more ports 305. By way of example, only a single port 305 may be provided to remove a flow of water from the tank to be externally heated, and that flow of water may be returned to the tank 300 by way of the outlet port 304. It should further be understood that one or more ports 305 can be alternatively or additionally be provided for other purposes, such as (for example) for a temperature and pressure relief valve, a drain valve, a gas control valve, to extend heating elements or temperature probes into the internal volume of the tank 300 in a leak-free manner, etc.

The spud weld connection 100 includes a spud body 200 (FIG. 2) that is welded to an outer surface 306 of the cylindrical tank wall 301. As depicted in FIGS. 2 and 3, the spud body 200 is a metal component with an arcuate and concave first end surface 201 and a planar second end surface 202. The spud body 200 can be machined, cold-headed, or produced using other known methods. The first and second end surfaces are spaced apart from one another, and the spud body 200 has an outer surface 203 that is arranged between the end surfaces 201, 202. The outer surface of the exemplary embodiment includes a cylindrical surface with chamfers at the interfaces to the end surfaces, but it should be understood that the outer surface 203 is not limited to such a shape and can have other shapes such as, for example, square, hexagonal, octagonal, etc.

The spud body 200 further includes a central bore 204 that extends through the spud body 200, penetrating both the first end surface 201 and the second end surface 202 to allow for fluid flow and/or physical access through the spud body. The exemplary spud body has a female thread profile 205 provided within the central bore, to allow for the easy connection of a standard threaded pipe nipple to the spud body 200 for connection to other portions of a plumbing system. In other embodiments, the thread profile 205 can be omitted, and such a connection can be made by other means such as, for example, welding.

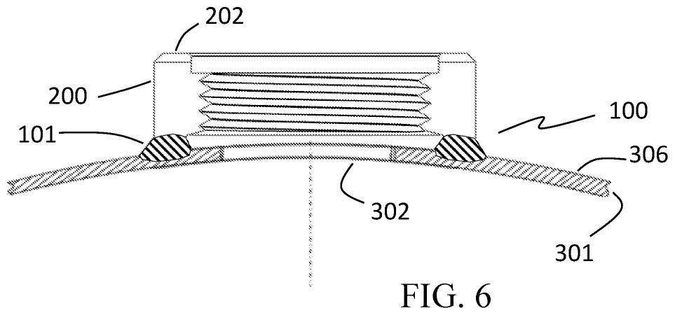

As best seen in the cross-sectional view of FIG. 6, the spud weld connection 100 further includes an aperture 302 that extends through the cylindrical tank wall 300 in order to allow access to the internal tank volume through the spud body 200. A weld joint 101 is formed between the first end surface 201 of the spud body 200, and an outer surface 306 of the cylindrical tank wall 301. In the exemplary embodiment, the weld joint 101 is an autogenous weld joint that results from the from the melting and fusing of the material at the second end 201 of the spud body 200 and the material of the tank wall 301.

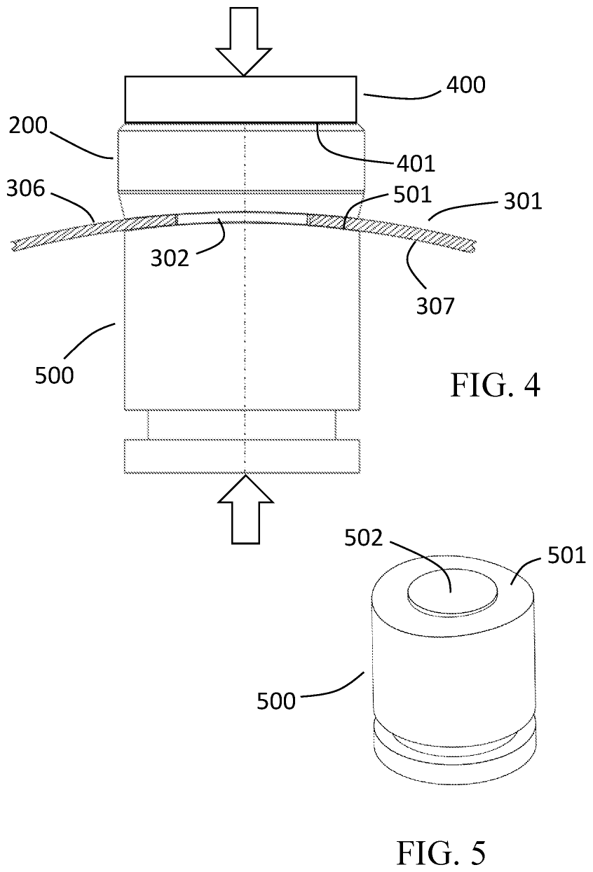

As can be seen in FIG. 4, depicting the spud body 200 engaged against the cylindrical tank wall 301 prior to the weld joint 101 having been created, the concave end surface 201 of the spud body 200 defines an arcuate shape that generally corresponds to the cylindrical outer surface 306 of the tank wall 301. Accordingly, those surfaces can be placed into contact with one another without requiring any substantial distortion of the tank wall 301 during the formation of the weld joint 101. In contrast, prior weld joints using a planar end surface of the spud body at the weld joint required either such a distortion, or the addition of substantial weld filler metal in order to create the weld joint. Either of these have been found to increase the magnitude of the stress riser created at the spud, which has been found to lead to reduced fatigue life of the water heater tank.

FIG. 4 depicts, in part, a welding process according to an embodiment of the invention. The spud body 200 is placed against the tank wall 301 such that the two surfaces 201, 306 are in contact with one another and the aperture 302 is generally aligned with the central bore 204. A first welding electrode, depicted generally at 400, is disposed against the spud body 200 with a planar face 401 of the electrode 400 engaging against the planar surface 202 of the spud body 200. A second welding electrode 500 is arranged within the cylindrical tank wall 301, and an arcuate and convex surface 501 of the second electrode (best seen in FIG. 5) is disposed against the cylindrical inner surface 307 of the cylindrical wall 301. The arcuate and convex surface 501 preferably generally corresponds to the shape of the inner surface 307, so that the entire or nearly the entire surface 501 can be disposed against the surface 307 without causing distortion of the wall 301. The second electrode 501 can optionally be provided with a projection 502 (shown in FIG. 5) that is geometrically matched to the aperture 302 in the tank wall, in order to facilitate the proper alignment of the electrode 500 along the inner surface 307.

During the welding process, a clamping force is applied through the first and second electrodes 400 and 500 in direction that are generally perpendicular to the surface 202 of the spud body 200, as generally depicted by the arrows in FIG. 4, in order to provide an intimate contact between the spud body surface 201 and the outer surface 306 of the cylindrical tank wall 301. Due to both the arcuate, concave shape of the stud body surface 201 and the arcuate, convex shape of the electrode surface 501, a high clamping force can be achieved with reduced distortion of the cylindrical wall 301. An electrical current is passed through the spud body 200 and tank wall 301 from one of the electrodes to the other while the clamping force is maintained, thereby forming a weld joint 101 at the point of contact.

In at least some embodiments, the arcuate shape of the concave end surface 201 of the spud body 200 can define a cylindrical shape with a diameter that is equal to, or approximately equal to, the diameter of the outer surface 306. In such embodiments, the cylindrical shape of the concave end surface 201 defines an axis of revolution that is in alignment with a central axis of the cylindrical tank wall 300, so that the surfaces are concentric. In other embodiments, a diameter defined by the surface 201 can intentionally vary from the diameter of the outer surface 306. In such embodiments, the axis of revolution define by the concave end surface 201 is parallel with the central axis of the cylindrical tank wall 300, but is offset therefrom. Such an intentional variation, when maintained within a defined range, can allow for the same size spud body 200 to be used with a variety of differing tank sizes without compromising the weld joint 101. By way of example, a spud body with an arcuate concave surface defining a cylindrical diameter of 17″ may be used on cylindrical tank walls with outer diameters of 12″, 14″, 18″, 24″, 26″ etc. In other words, the outer diameter of the cylindrical tank wall varies between about 70% and 150% of the diameter of the spud body surface that is to be welded to the tank wall. Since the size of the central bore that needs to be encircled by the weld joint is relatively small (e.g., on the order of 1-2″) in comparison to the tank wall diameter, the amount of tank wall distortion that would be necessary to place the welding surfaces in intimate contact at the extremes of those mismatches in diameter is still minor in comparison to a planar spud surface.

Various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

What is claimed is:

1. A spud weld connection to a cylindrical tank wall, comprising:
a spud body having an arcuate and concave first end surface, a planar second end surface spaced apart from the first end surface, an outer surface arranged between the first and second end surfaces, and a central bore extending through the spud body;
a weld joint between the first end surface and an outer surface of the cylindrical tank wall; and
an aperture extending through the cylindrical tank wall and surrounded by the weld joint.

2. The spud weld connection of claim 1, wherein the arcuate first end surface is concentric with the cylindrical tank wall.

3. The spud weld connection of claim 1, wherein the outer surface of the cylindrical tank wall has a first diameter, the first end surface has a second diameter, and the first diameter is between 70% and 150% of the second diameter.

4. The spud weld connection of claim 1, wherein the central bore includes a female thread profile.

5. A method of creating a spud weld connection to a cylindrical tank wall, comprising:
providing a cylindrical tank wall having an aperture extending therethrough;
providing a spud body having an arcuate and concave first end surface, a planar second end surface spaced apart from the first end surface, an outer surface arranged between the first and second end surfaces, and a central bore extending through the spud body;
disposing the arcuate and concave first end surface of the spud body against an outer surface of the cylindrical tank wall such that the first end surface surrounds the aperture;
placing a planar surface of a first welding electrode against the planar second end surface of the spud body;
placing an arcuate and convex surface of a second welding electrode against an inner surface of the cylindrical tank wall, in alignment with the first welding electrode;
applying a compressive force to the spud body and cylindrical tank wall through the first and second electrodes, and
conducting an electrical current through the spud body and cylindrical tank wall between the first and second electrodes in order to create a weld joint around the aperture between the spud body and the cylindrical tank wall at the first end surface.

6. The method of claim 5 wherein the second welding electrode includes a protrusion extending from the arcuate and convex surface, further comprising inserting the protrusion into the aperture in order to align the second welding electrode with the first welding electrode.

7. The method of claim 5, wherein the outer surface of the cylindrical tank wall has a first diameter, the first end surface has a second diameter, and the first diameter is between 70% and 150% of the second diameter.
